(19) United States
(12) Patent Application Publication
(10) Pub. No.: US 2010/0067000 A1
(43) Pub. Date: Mar. 18, 2010

(54) Raman spectroscopy

(75) Inventors: Jeremy J. Baumberg, Southampton (GB); Mamdouh Abdelsalam, Southampton (GB); Phillip N. Bartlett, Southampton (GB); Andrea Russell, Southampton (GB); Yoshihiro Sugawara, Southampton (GB); Suzanne Pelfrey, Southampton (GB)

Correspondence Address: RENNER OTTO BOISSELLE & SKLAR, LLP, 1621 EUCLID AVENUE, NINETEENTH FLOOR, CLEVELAND, OH, 44115, US

(73) Assignee: University of Southampton, Highfield, Southampton (GB)

(21) Appl. No.: 11/575,043

(22) PCT Filed: Sep. 7, 2005
(86) PCT No.: PCT/GB05/03454

§ 371 Date: Mar. 6, 2009

(30) Foreign Application Priority Data
Sep. 10, 2004 (GB) 0420158.8

(51) Int. Cl. G01J 3/44

(52) U.S. Cl. 356/301

(57) ABSTRACT

It has been discovered that specially structured metallic films containing voids can deliver a hugely enhanced surface enhanced Raman spectroscopy (SERS) effect. By selecting a particular size and geometry for the voids, metallic films can be provided which have an enhanced photon-to-plasmon conversion efficiency for incident radiation of a predetermined wavelength. Controllable surface-enhanced absorption and emission characteristics may thus be provided, which are useful for SERS and potentially also other optical spectrometry and filtering applications. With such a large Raman signal, the invention enables fast, compact and inexpensive Raman spectrometers to be provided opening up many new application possibilities.

### FIELD OF THE INVENTION

The invention relates principally but not exclusively to Raman spectroscopy, in particular surface enhanced Raman spectroscopy (SERS).

### BACKGROUND OF THE INVENTION

Raman spectroscopy is used for a variety of applications, most commonly to study vibrational quanta, such as vibrations in molecules or phonons in solids, although other quantised entities can also be studied. Raman spectroscopy can provide detailed information relating to the physical state of sample materials and can be used to distinguish various states of otherwise chemically identical molecules, such as various molecular isomers, from one another.

Raman spectroscopy finds wide ranging use in numerous different industries. By way of example, Raman spectroscopy finds application in the pharmaceutical, chemical, bio-analysis, medical, materials science, art restoration, polymer, semiconductor, gemology, forensic, research, military, sensing and environmental monitoring fields.

Although Raman spectroscopy is an extremely useful analytical tool, it does suffer from a number of disadvantages. The principal drawbacks associated with Raman spectroscopy arise because of the small scattering cross-section. Typically, only 10⁻⁷ of the photons incident on the sample material will undergo Raman scattering. Hence, in order to detect Raman scattered photons, Raman spectrometers typically employ high power laser sources and high sensitivity detectors. Not only is the scattering cross-section small in an absolute sense, but it is small relative to Rayleigh scattering in which the scattered photon is of the same energy as the incident photon. This means that there are often problems related to separating out the small Raman signal from the large Rayleigh signal and the incident signal, especially when the Raman signal is close in energy to the incident signal.

High power sources are not only both bulky and expensive, but at very high power the intensity of the optical radiation itself can destroy the sample material, thus placing an upper limit on the optical radiation source intensity. Similarly, high sensitivity detectors are often bulky and expensive, and even more so where forced cooling, such as with liquid nitrogen, is necessary. Additionally, detection is often a slow process as long integration periods are required to obtain a Raman spectrum signal having an acceptable signal-to-noise ratio (SNR).

The problems associated with Raman spectrometry have been known long since C. V. Raman discovered the effect itself in 1928. Since that date, various techniques have been applied to improve the operation of Raman spectrometers.

Certain of the techniques involve the use of metal surfaces to induce surface plasmon resonance (SPR) for more efficient coupling of energy into the sample material. One refinement of this technique involves placing sample material on or near a roughened surface. Such a surface can be formed by the deposition of metallic/dielectric particles, sometimes deposited in clusters [1-3]. The roughened surface is found to give rise to an enhanced Raman signal, and the technique of using the roughened surface to obtain a Raman spectrum is known as surface enhanced Raman spectroscopy (SERS).

However, whilst SERS devices can lead to an improved SNR when compared to previous conventional Raman spectrometers, they still suffer to a lesser extent with various of the same disadvantages. For example, SERS devices are still not efficient enough to provide a Raman signal without fairly long detector integration times, and can still require the use of bulky and expensive detectors. Even at present, an acquisition time for a Raman spectrum of some five seconds is considered to be extremely good.

### SUMMARY OF THE INVENTION

According to a first aspect of the invention, there is provided a spectrometer for obtaining a Raman spectrum from a sample material. The spectrometer comprises an optical source for generating optical radiation, a substrate for receiving the optical radiation, and a spectral analyser for analysing the Raman scattered radiation emerging from the substrate. The substrate comprises a metallic film that incorporates a plurality of voids of a predetermined size. These voids are suitable for confining surface plasmons. The surface plasmons couple energy from incident optical radiation to a sample material when the sample material is located proximal the substrate. The surface plasmons are also responsible for converting scattered energy emitted from the sample material into the Raman scattered radiation. The substrate may be incorporated into existing Raman spectrometers in order to improve their performance.

The substrate provides an enhanced Raman signal. Therefore to obtain an acceptable SNR, less incident optical radiation or a lower sensitivity detector can be used, or both. In various embodiments, the spectral analyser makes use of detectors that do not need to be cooled, such as a photodiode array. Certain embodiments can make use of high efficiency compact optical source devices, such as a laser diode or laser diode array. By employing such detectors and arrays, a high efficiency, low-power, portable, and compact Raman spectrometer can be provided. Moreover, embodiments employing, for example, a laser diode array provide optical radiation that can be used to illuminate large area of substrate. In various such embodiments, it is not always necessary to focus the optical radiation, thereby further improving the compactness and reducing the cost of these spectrometer.

Moreover, because of the enhanced Raman signal, input channel optics provided with the spectral analyser to collect Raman scattered radiation may be made to differ from optics used in conventional Raman spectrometers. In particular, various embodiments avoid the need to use a high numerical aperture lens system to collect Raman scattered radiation. This allows the collection optics to be spaced away from the substrate. Such spacing is particularly beneficial as it enables fluids containing sample material to be analysed to freely flow over the substrate without being impeded by the collection optics. The fluid may be liquid or gas. The input channel optics may comprise a fibre optic input channel oriented towards the substrate. As in various embodiments the direction of emerging Raman signal can be predicted, use of a fibre optic input channel can be used to cut down on any background signal from the optical source that reaches the spectral analyser.

Further, since the signal is strong, alignment and focusing tolerances of the optical components are much relaxed so that, for example, the need to provide for adjustability of the optical components to allow signal optimisation before each experimental series can in some cases be dispensed with entirely.

Furthermore, since the Raman signal is enhanced, a Raman spectrometer incorporating the substrate is able to acquire a Raman spectrum having an acceptable SNR using a reduced integration time. Not only does this enable faster processing of sample materials, but it also opens up the exciting possibility of using Raman spectroscopy to monitor processes in real-time, such as chemical reactions and catalysis processes.

Although the applicants have for several years been involved in research relating to producing and investigating the optical properties of metallic films which include voids [4, 5, 6, 9], the fact that these films were capable of delivering huge SERS enhancement was not previously realised since their physical structure differs greatly from that of any surfaces previously used.

However, when it was tried out, the results showed huge enhancements in the Raman signals. These initial experiments indicated that the Raman signal could be increased by a factor of between some 10⁴ to 10¹⁴ when compared to non-SERS apparatus.

Moreover, experimental and theoretical investigations detailed below have indicated that the Raman signal can be increased by at least a factor of two when compared to conventional SERS apparatus by careful design of the voids to optimise them for particular wavelengths of incident optical energy.

Additionally, the theoretical and experimental studies show that by careful design of the voids, the Raman signal can be concentrated to be emitted at a predetermined angular direction, thereby allowing appropriately positioned low NA collection optics to be used to collect the signal.

Whilst the origins of the enhanced Raman signal are not completely understood, it is believed that it may be due to the effect of localised plasmons that form at the surfaces of the voids. It is thought that the localised plasmons increase the coupling efficiency between the incident optical radiation and any sample material located proximal the surface of the metallic film, and subsequently give rise to the dramatic enhancements in Raman signal strength that are seen by the applicant.

In various embodiments, the voids have the shape of a truncated sphere. By controlling the diameter of the sphere and the thickness of the truncation, the emission direction of a particular wavelength of Raman signal can be tailored in a known and predictable manner detailed further below. Additionally, by providing part-spherical voids with truncation parallel to a surface of the substrate, the emission direction remains predictable and constant even if the substrate is rotated about an axis normal to the surface. Alignment of the substrate within the spectrometer is thereby facilitated.

The size of the voids may be selected depending upon the wavelength of the optical radiation that is to be used with a particular sample material. Substrate responses may thus be tailored to suit a particular sample material. The voids may range from about a few nanometres to about many tens of microns in size. For example, the size of the voids may range from about 10 nm to 50 nm for working with deep ultraviolet radiation, to about tens of microns for working with mid-infrared radiation tuned to be resonant to molecular vibrational transitions. In other examples, a void may be provided with a diameter from about 100 nm to about 900 nm due to the ease of manufacturing voids of this size. For still further examples, the size of the voids may correspond substantially to the wavelength of visible optical radiation. Voids may be used with optical radiation that is selected so to be non-ionising and so as not to induce extraneous molecular vibrations for a particular sample material. This allows the optical radiation merely to probe the sample material without unduly influencing it.

Certain embodiments include a substrate that is generally planar in shape and in which the voids are uniformly spaced over at least part of a planar surface of the substrate. Efficient use can thus be made of the surface, and a uniform signal for Raman spectra can be obtained from different parts of the substrate surface.

Various embodiments incorporate a substrate that further comprises a waveguide structure for coupling the optical radiation to a sample material through the metallic film. Where such a waveguide structure is provided, the spectral analyser may also be configured to collect Raman scattered radiation that emerges from the waveguide.

According to a second aspect of the invention, there is provided a method of obtaining a Raman spectrum from sample material. The method comprises introducing sample material into the spectrometer according to the first aspect of the invention proximal to the substrate, activating the optical source and operating the spectral analyser to provide the Raman spectrum of the sample material.

The method may comprise a step of introducing sample material by flowing a fluid containing the sample material across the substrate in a region illuminated by the optical radiation. The substrate is particularly good for this because, besides being positionable away from any light collecting optics, it may be provided with a smooth surface.

In various embodiments, the method comprises varying the electric potential of the metallic film of the substrate. Applying a electric potential to the metallic film allows the dynamics of the sample material proximal the surface of the voids to be monitored. Moreover, it can permit real-time surface reaction monitoring, enable chemical reactions to be initiated, enable the breakdown of various molecules to be monitored, and be used to provide information about how Raman spectra are modified by the presence of electric fields.

According to a third aspect of the invention, there is provided a method of making a substrate having an enhanced efficiency of coupling optical energy to surface plasmons at a predetermined wavelength of optical radiation incident upon the substrate. The method comprises determining the size and shape of voids which when formed in a metallic film efficiently couple optical energy at the predetermined wavelength to surface plasmons that form in the voids, and forming a substrate comprising a metallic film that includes a plurality of voids of the determined size and shape.

The size and shape of the voids determines whether optical radiation of a particular predetermined energy will couple into plasmons that form at the surface of the voids. Furthermore, the applicant has found that by modifying the size and shape of the voids and the incident direction of the optical radiation, both optical-to-plasmon and plasmon-to-optical energy couplings can be controlled as well as the orientation of optical radiation emitted from the metallic film.

Voids may be formed in the metallic film that are uniformly spaced over a surface of the substrate. A waveguide structure may be formed in the substrate for coupling optical radiation from the substrate through the metallic film.

In various embodiments, the voids are in the shape of a truncated spherical void. The size of these voids are determined in dependence upon the desired wavelength of the optical radiation. The diameter of the truncated spherical void may be chosen to be of the same order of magnitude as the predetermined wavelength of optical radiation. For example, the diameter of the truncated spherical void may be chosen to be about equal to the wavelength of optical radiation. In various examples, the diameter of the truncated sphere is from about 50 nm to about 10,000 nm, or about 100 nm to about 900 nm. The thickness of the truncated spherical void may be chosen to couple optical energy at the predetermined wavelength to zero-dimensional plasmons that form in the void.

The substrate may be formed by depositing a template of ordered spherical particles on a substrate surface, and passing a predetermined amount of charge though a metallic ion containing solution that surrounds the template so as to deposit the metallic film on the substrate surface.

The third aspect of the invention relates to how to apply the experimental and theoretical information obtained by the applicant so as to design and manufacture substrates having tailored emission characteristics. Through the applicant's investigations, the applicant has come to understand how to produce the metallic films necessary for efficient use in various applications or with various sample materials. Numerous applications for such substrates are envisaged. For example, applications are envisaged in spectrometry, such as Raman spectrometry, and in optical filtering.

According to a fourth aspect of the invention, there is provided a substrate made according to the method of the third aspect of the invention. Such substrates may incorporate a metallic film that comprises one or more of the following materials: gold, platinum, silver, copper, palladium, cobalt and nickel. It will be appreciated that the metallic film may be made of any one of these elements alone or in combination with each other or other materials to form an alloy. Materials that have catalytic properties, inert properties, optically beneficial properties, etc. may be preferred depending upon the application of the substrate. For example, silver may be used to provide a high Raman enhancement signal in applications where it is unlikely to be placed in contact with oxidising materials that would otherwise degrade its optical performance. The substrates may be encapsulated.

In various embodiments the substrate may be provided already with a sample material for analysis provided in the voids of the metallic film. In certain embodiments, the sample material is an organic material. Provision of substrates with sample materials is convenient for users, particularly where the sample materials have undesirable chemical or biological properties, such as high toxicity.

According to a fifth aspect of the invention, there is provided an optical device incorporating the substrate according to the fourth aspect of the invention. A sixth aspect of the invention relates to the use of the optical device according to the fifth aspect of the invention. For example, such an optical device may be a filter device, an analysis device or a device other than a Raman spectrometer.

### BRIEF DESCRIPTION OF THE DRAWINGS

For a better understanding of the invention and to show how the same may be carried into effect reference is now made by way of example to the accompanying drawings in which:

FIG. 1 shows a conventional Raman spectrometer;

FIG. 2 shows a first embodiment of a Raman spectrometer according to the present invention;

FIG. 3 shows a second embodiment of a Raman spectrometer according to the present invention;

FIG. 4 shows a third embodiment of a Raman spectrometer according to the present invention;

FIG. 5 is a flow diagram illustrating a method of obtaining a Raman spectrum from a sample material according to an embodiment of the invention;

FIG. 6 shows a Raman spectrum of benzenethiol obtained using the first embodiment of a Raman spectrometer according to the present invention;

FIG. 7 shows a set of Raman spectra of pyridine obtained with different electric potentials applied in solution to the metallic film of the first embodiment of a Raman spectrometer according to the present invention;

FIG. 8 shows modelled data indicating predicted Raman signal enhancement factors for substrates incorporating metallic films made using various metals in accordance with the present invention;

FIG. 9 is a flow diagram illustrating a method of making a substrate having an enhanced efficiency of coupling optical energy to surface plasmons at a predetermined wavelength of optical radiation according to an embodiment of the present invention;

FIG. 10A shows a schematic illustration of a plasmon formed in a void according to various embodiments of the present invention;

FIG. 10B shows a schematic illustration of a void having a truncated spherical shape for use in various embodiments of the present invention;

FIG. 10C shows a perspective view of a metallic film in a substrate according to an embodiment of the present invention;

FIG. 10D shows a plan view of the metallic film of FIG. 10C taken using a scanning electron microscope (SEM);

FIG. 11 schematically shows the first embodiment of a Raman spectrometer according to the present invention in one mode of operation;

FIG. 12 schematically illustrates the process of surface enhanced Raman spectroscopy used for various embodiments of the present invention;

FIG. 13A schematically shows plasmon field strength on a metallic sphere;

FIGS. 13B to 13G schematically show plasmon field strengths in a perfect spherical void for plasmons of varying angular momentum;

FIG. 14A shows a reflection spectrum for different thickness truncated spherical voids in a gold metallic film used in various embodiments of the present invention;

FIG. 14B shows plasmon modes for different thickness truncated spherical voids in a gold metallic film used in various embodiments of the present invention;

FIG. 15 shows data indicating how the reflectivity of a gold metallic film of varying thickness varies according to the wavelength of incident optical radiation and for different angles of incidence, polarisation and metallic film orientation;

FIG. 16A is a schematic illustration of a plasmon formed in a void by coupling of optical radiation from a waveguide formed in a substrate for use in various embodiments of the present invention;

FIG. 16B is a schematic illustration of a plasmon formed in a void decaying to generate optical radiation in the waveguide shown in FIG. 16A;

FIG. 17A is a schematic illustration of a combined void and metal sphere for enhancing Raman signal in various embodiments of the present invention;

FIG. 17B is a schematic illustration of a microcavity formed by a void and a reflector for selectively enhancing Raman signal in various embodiments of the present invention;

FIG. 17C is a schematic illustration of a void bounded by an overhanging layer for enhancing Raman signal in various embodiments of the present invention;

FIG. 17D is a schematic illustration of a void bounded by an over-etched layer for enhancing Raman signal in various embodiments of the present invention;

FIG. 18 is an optical device for filtering optical radiation incorporating a substrate according to an embodiment of the present invention; and

FIG. 19 is a flow diagram illustrating a method of using the optical device of FIG. 18.

### DETAILED DESCRIPTION

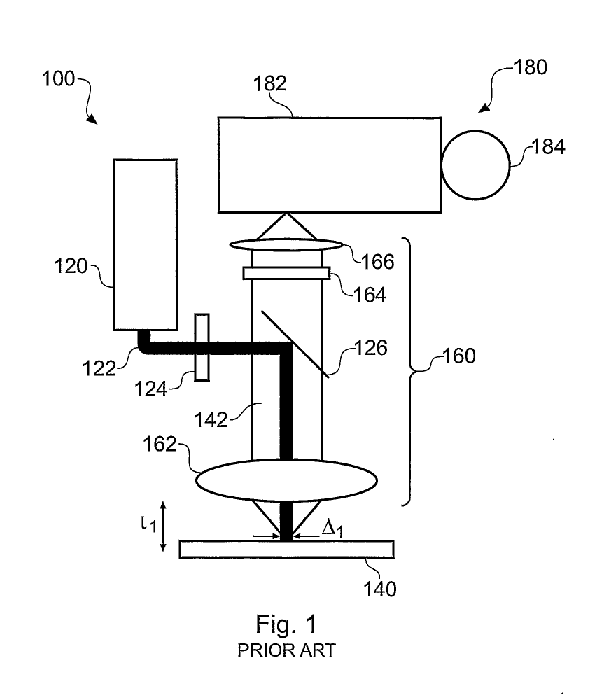

FIG. 1 shows a conventional Raman spectrometer 100. For example, the spectrometer 100 may comprise various elements of the in Via range of Raman microscopes available from Renishaw plc of Wotton-under-Edge, Gloucestershire, UK. The spectrometer 100 comprises an optical source 120, a spectral analyser 180 and input channel optics 160 for collecting Raman scattered radiation 142 and directing it to the spectral analyser 180. The optical source 120 generates a beam of optical radiation 122 which is filtered by a first filter 124. The filtered optical radiation 122 is directed by beam splitter 126 on to a sample 140. Raman scattered radiation 142 generated by the sample 140 is collected by input channel optics 160 for analysis by the spectral analyser 180.

The input channel optics 160 comprises a microscope objective lens 162 a second filter 164 and a lens 166. The microscope objective lens 162 has a high numerical aperture (typically 0.4 or more) in order to gather as much Raman scattered radiation 142 as possible from the sample 140. The second filter 164 is designed to block any reflected optical radiation 122 that is not Raman scattered. The lens 166 focuses the Raman scattered radiation 142 in to the spectral analyser 180.

The spectral analyser 180 comprises a spectrum separator 182 and a CCD detector 184. The spectrum separator 182 spatially separates different frequencies of Raman scattered radiation 142. A rotating grating (not shown) may be used to sweep different wavelengths of Raman scattered radiation 142 across an aperture placed in front of the CCD detector 184. The CCD detector 184 is cooled in order to be able to detect low levels of Raman scattered radiation 142. Other parallel or single channel detectors may be used.

The microscope objective lens 162 needs to be placed close to the sample 140 in order to collect as much Raman scattered radiation 142 as possible. The microscope objective lens 162 collects Raman scattered radiation 142 from an area having a diameter of about Δ₁. Typically, Δ₁ is less than 10 micrometers. Additionally, the microscope objective lens 162 needs to be placed close to the sample 140. The microscope objective lens 162 and the sample 140 are separated by a distance L₁ which is typically less than 1 mm.

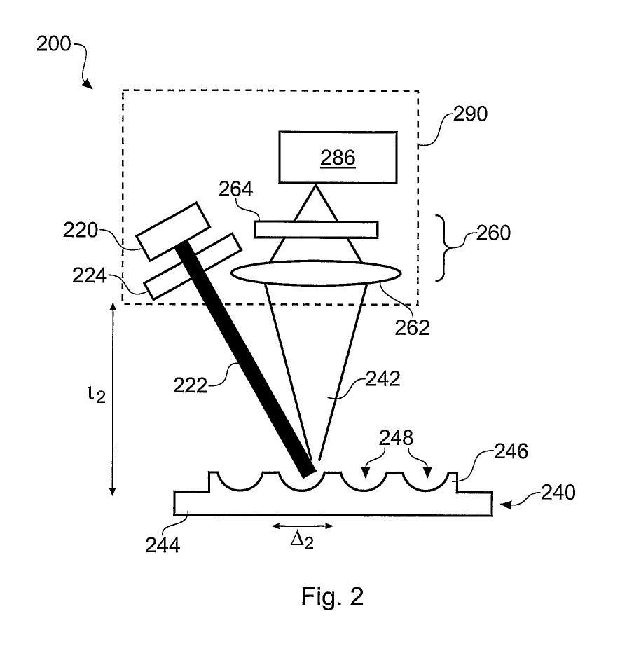

FIG. 2 shows a Raman spectrometer 200 according to a first embodiment of the invention. The spectrometer 200 comprises a source/detector package 290 and a substrate 240. The source/detector package 290 comprises an optical source 220 and a first filter 224 for filtering optical radiation 222 generated by the optical source 220. The package 290 also includes input channel optics 260 and a spectral analyser 286.

The input channel optics 260 comprises a first lens 262 for gathering Raman scattered radiation 242 and a second filter 264 for rejecting any non-Raman scattered radiation. The input channel optics directs Raman scattered radiation to the spectral analyser 286.

The source/detector package 290 is configured to direct optical radiation 222 on to the surface of the substrate 240 and to collect Raman scattered radiation 242 that is generated by a sample that is placed proximal to the surface of the substrate 240. The substrate 240 comprises a support layer 244 with a metallic film 246 formed thereon. The metallic film 246 comprises a plurality of voids 248. The voids 248 generate and confine surface plasmons that couple energy from the optical radiation 222 to a sample material (not shown). The plasmons also convert scattered energy emitted from the sample material into Raman scattered radiation 242. The plasmons give rise to a surface enhanced effect which increases significantly the amount of Raman scattered radiation 242. This in turn means that the optical radiation 222 does not necessarily need to be tightly focused in order to generate a significant Raman signal. Additionally, it also allows use of a lens 262 which need not have a high numerical aperture.

The focal spot size of the optical radiation 222, Δ₂, can be greater than 100 micrometers. This further enhances the Raman scattered radiation 242 since it enables a large number of sample material molecules to be illuminated at any one time. Moreover, as will be seen later on, careful design of the size and shape of the voids 248 enables the direction at which the Raman scattered radiation 242 emerges to be controlled and predicted so that appropriately positioned small solid angle collection optics is capable of collecting a high proportion of the Raman scattered signal.

The optical source 220 can be a small laser diode having an output power of several tens of milliwatts. A laser diode array may also be used. The input channel lens 262 is separated from the substrate 240 by a distance L₂. Since the lens 262 need not have a high numerical aperture it can be separated from the substrate 240 by distances of 1 cm or more. Preferably, the lens 262 (or an alternative optical radiation gathering aperture such as, for example, a fibre optic) will have a numerical aperture of less than 0.4. More preferably, the numerical aperture will be less than 0.1. This allows the Raman spectrometer 200 to be used to analyse fluids (liquids/gasses) flowing over the substrate 240.

The spectral analyser 286 comprises apparatus for spectral separation of the Raman scattered radiation 242 and a detector for measuring the Raman scattered radiation 242. In this embodiment, the spectral analyser 286 comprises a fixed grating and an array of diodes (not shown) for detecting the spectral components of the Raman scattered radiation 242. It is understood that conventional scanning spectrum separators may be used to detect Raman scattered radiation 242. For example, a precision grating stage and optionally a detector from Renishaw plc's in Via Raman microscope range may be used. However, an advantage of the present embodiment is that the spectrometer 200 can be made to be ultra compact and portable. In addition reliability and detection speed are improved with respect to conventional spectrometers since it is not necessary to use a mechanically operated spectrum separator to sweep across the range of Raman scattered radiation wavelengths.

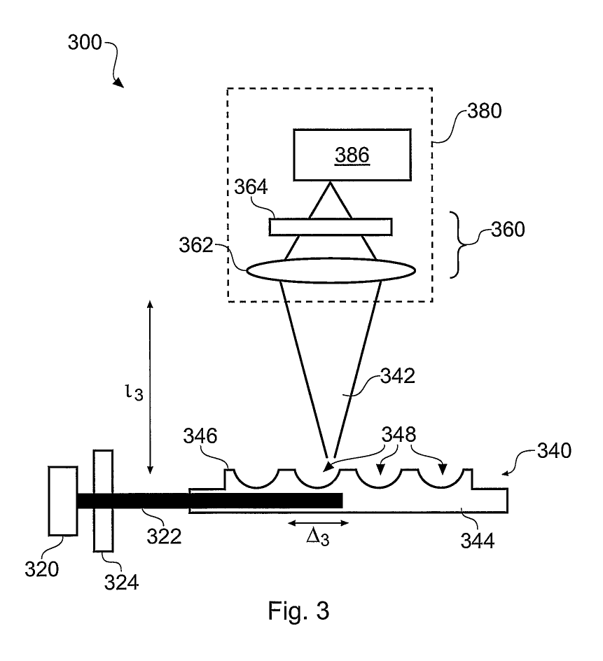

FIG. 3 shows a Raman spectrometer 300 according to a second embodiment of the invention. The spectrometer 300 comprises an optical source 320, a substrate 340 and a detector package 380.

The optical source 320 comprises a laser diode. The laser diode generates a beam of optical radiation 322 that is filtered by a first filter 324 to provide a monochromatic beam. The optical radiation 322 is coupled in to an optically transparent support layer 344 of the substrate 340. A blazed grating is written in to the support layer 344 for coupling the optical radiation 322 from the support layer 344 in to a metallic film 346 formed on the support layer 344. Optical radiation 322 excites plasmons in voids 348 that are formed in metallic film 346.

Sample material is placed in the voids 348 and excites Raman scattered radiation 342 in response to the plasmons generated by the optical radiation 322. The Raman scattered radiation 342 is emitted from the metallic film 346 in a direction that depends upon the shape and size of the voids 348. Raman scattered radiation 342 is captured by the detector package 380 and converted in to a Raman signal that represents the spectrum of the Raman scattered radiation 342. Raman scattered radiation 342 is captured by a lens 362 which is separated from the substrate 340 by a distance L₃. L₃ can be a distance greater than 1 cm. Raman scattered radiation collected by the lens 362 is filtered by a second filter 364 used to reject non-scattered light emerging from the substrate 340. The filtered Raman scattered radiation is converted by a spectral analyser 386 in to a Raman signal.

A spectral analyser 386 comprises a spectrum separator. In this case, the spectrum separator includes a fixed grating which separates the Raman scattered radiation 342 into various spectral components. The spectral components are angularly separated and impinge upon a diode array contained within the spectral analyser 386. Each diode of the diode array is used to measure a spectral component of the Raman scattered radiation 342.

Electronic circuitry coupled to the diode array logs the spectrum for the Raman scattered radiation 342. The electronic circuitry (not shown) can be coupled to a computer system for logging and manipulating the Raman spectrum data. Software may be provided to identify a particular type of substrate material in dependence upon the measured Raman spectrum.

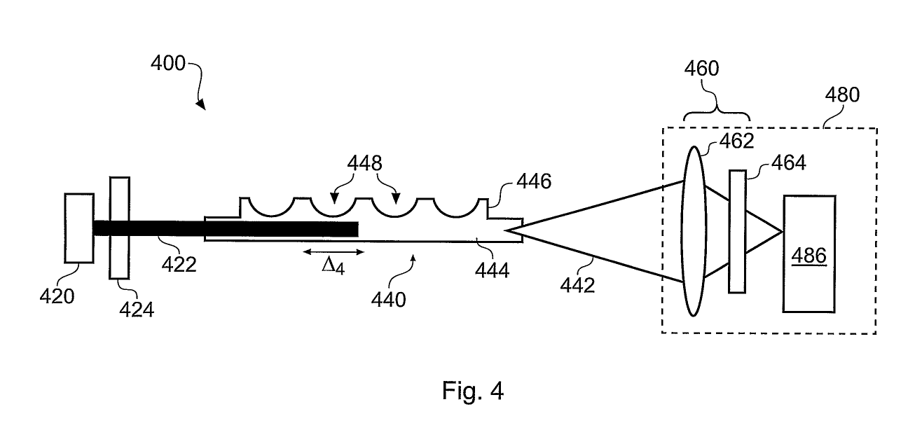

FIG. 4 shows a Raman spectrometer 400 according to a third embodiment of the invention. The Raman spectrometer 400 comprises an optical source 420 for generating optical radiation 422. The optical radiation 422 is filtered by a first filter 424 and guided in to an optically transparent support layer 444 formed in a substrate 440. The optical radiation 422 couples in to a metallic film 446 formed upon the support layer 444 over a distance of Δ₄. The distance Δ₄ can be greater than 100 micrometers.

Optical radiation 422 excites plasmons in voids 448 that are formed in the metallic film 446. The plasmons couple energy to sample materials that are located near the voids 448. The excited sample material gives rise to Raman scattered energy that couples via plasmons back in to the optically transparent support layer 444. The support layer 444 acts as a waveguide that guides Raman scattered radiation 442 through the support layer 444.

Detector package 480 is provided to detect the Raman scattered radiation 442 that emerges from the support layer 444. Detector package 480 comprises input channel optics 460 and a spectral analyser 486. The input channel optics 460 comprises a lens 462 and a second filter 464 that is used to reject elastically scattered photons generated by the optical source 420. The spectral analyser 486 comprises a fixed grating and a diode array. Each of the diodes in the diode array is used to detect a spectral component of the Raman scattered radiation 442.

Electronic circuitry (not shown) gathers data from each of the diodes in the diode array in order to reconstruct a Raman spectrum. The electronic circuitry can be configured to provide data relating to the Raman spectrum to a computer system for further analysis, identification or storage. For example, software running on such a computer system may be used to identify a particular sample material according to the measured Raman spectrum.

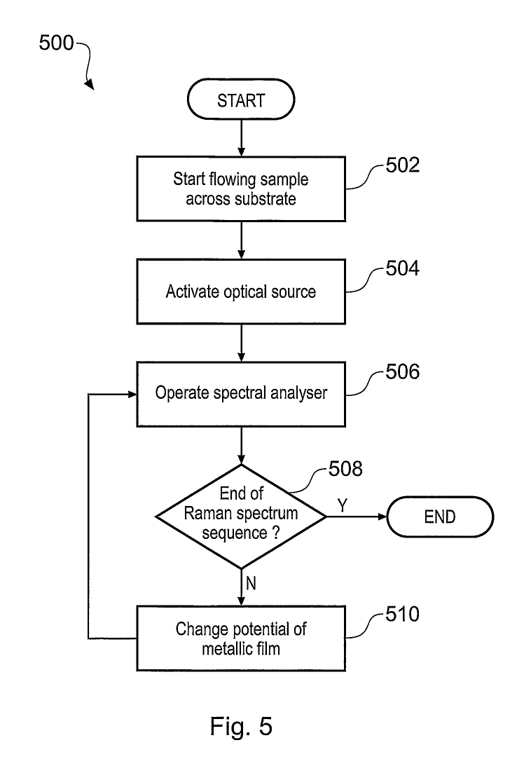

FIG. 5 is a flow diagram illustrating method 500 of obtaining a Raman spectrum from a sample material. The method 500 can be used in conjunction with the Raman spectrometers described in connection with FIGS. 2 to 4.

Step 502 comprises flowing a fluid containing a sample material across the surface of a substrate that contains a plurality of voids.

Step 504 is a step of activating an optical source to generate optical radiation for generating surface plasmons that are confined by the voids. The surface plasmons excite an enhanced Raman scattered radiation signal from the sample material.

Step 506 is a step of operating a spectral analyser to determine a Raman spectrum of the Raman scattered radiation generated in response to the activation of the optical source by the sample material. Operation of the spectral analyser may entail rotating a grating and recording a signal from a single photodetector. Alternatively, a photo diode array may be used with a fixed spectral separator.

Step 508 is a decision step. The decision step entails deciding whether further Raman spectra are required. This operation may for example be pre-programmed into a computer system which is operable to generate a plurality of Raman spectra and to control a Raman spectrometer. Where such a computer system determines that further spectra are to be obtained then the method moves on to step 510. Otherwise the method is ended.

Step 510 is a step at which the electric potential of the metallic film is varied. By varying the electric potential applied to the metallic film the physical properties of the sample material can be changed. Chemical reactions of an adsorbed species can be initiated at the substrate surface at a specific bias applied potential. Subsequently, variations in the adsorbed molecules can be tracked from a time sequence of their Raman spectra, obtained in real time using fast detection.

Once the potential of the metallic film has been incrementally changed, the method moves again to step 506 so that a further Raman spectrum can be obtained for the sample material which will be subject to a modified electric potential.

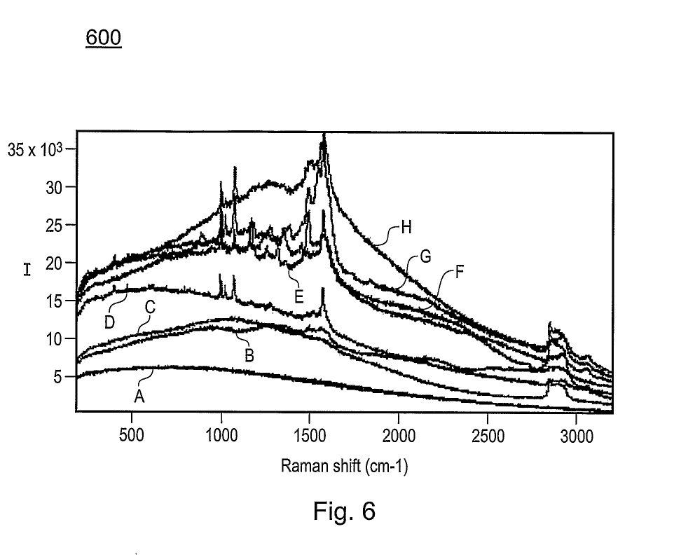

FIG. 6 shows Raman spectra 600 of a sample material containing benzenethiol obtained using the Raman spectrometer of FIG. 2. The Figure shows a set of Raman spectra obtained from benzenethiol placed on a substrate having a gold metallic film incorporating a plurality of voids. The voids had a truncated spherical shape 600 nm in diameter. Various thicknesses of films were used to produce the curves A to H shown in this Figure: A—100 nm; B—160 nm; C—220 nm; D—280 nm; E—340 nm; F—460 nm; G—52 nm; and H—400 nm. The spectra indicate how by varying the properties of the voids large enhancements of the Raman cross section can be provided. For a flat gold surface no signal was observed at all. However, as the physical properties of the voids were changed a maximum intensity enhancement of some 10⁴ was observed. Moreover, when the substrate was placed in a standard Raman spectrometer to obtain the results, the integration time for deriving each spectrum was only 50 milliseconds as compared to a standard conventional integration time of 5 seconds.

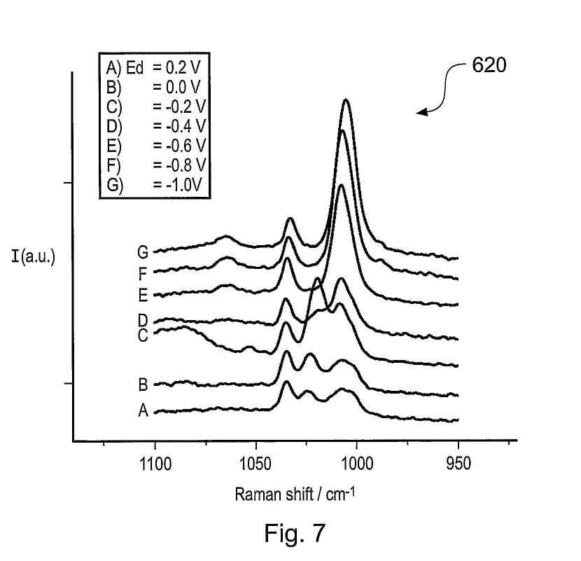

FIG. 7 shows a set of Raman spectra of pyridine obtained with different electric potentials applied to the metallic film in solution. Raman spectra curves A-G are shown vertically offset with respect to each other for clarity. The Raman spectra 620 were obtained using the Raman spectrometer shown in FIG. 2 operated according to the method shown in FIG. 5. The Raman spectra are enhanced by the effect of the structured substrate. In this case, by a factor of some 10⁵. As the electric potential applied to the metallic film is varied, it is noticeable that the spectra evolved to develop clearly defined sharp enhanced peaks. The main peaks in the curve when a potential of −1.0 volt is applied to the metallic film derive from the large number of molecules in solution (curve G). New peaks are observed to appear at critical potentials from 0.2 volts to −0.2 volts (curves A-C) which derive from just a few molecules adsorbed on the substrate, and which show the initiation of their chemical reaction directly observed as a change in molecular structure.

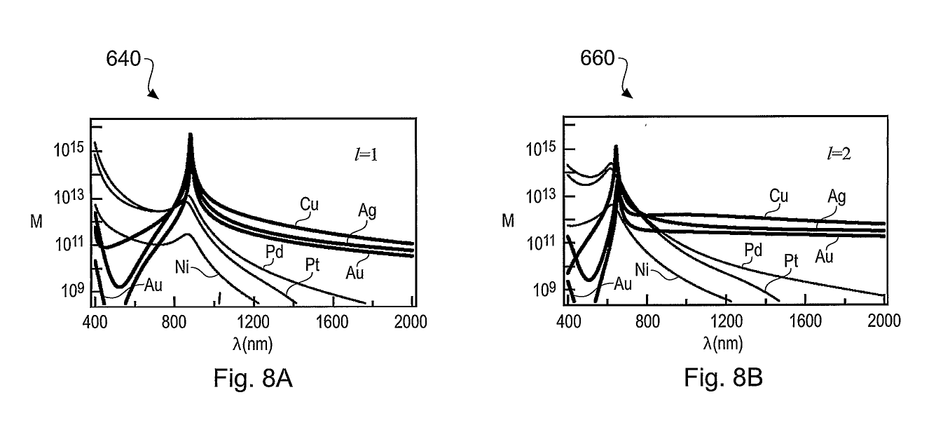

FIGS. 8A and 8B show modelled data indicating predicted Raman signal enhancement factors for substrates incorporating metallic films having a plurality of voids. The predicted enhancement factors are calculated using the following equation [4]:

∈ᵢHₗ(kₘa)[kᵢaJₗ(kᵢa)]′=∈ₘJₗ(kᵢa)[kₘaHₗ(kₘa]′ (1)

where Jₗ and Hₗ are spherical Bessel and Hankel functions, and the prime denotes differentiation with respect to the argument (ka). ∈ᵢ and ∈ₘ are the dielectric constants inside and outside the sphere, with kᵢ=\sqrt{∈ᵢ}ω/c and kₘ=\sqrt{∈ₘ}ω/c the corresponding wave numbers. We take ∈ᵢ=1 and assuming that the external material is an “ideal” metal with ∈ₘ(ω)=1−ωₚ²/ω², where ωₚ is the three dimensional plasmon frequency. Where frequencies are expressed in units of ωₚ, the solutions to Equation (1) for a sphere then depend only on the angular momentum quantum number 1, and the normalised sphere radius R=aωₚ/c. Symmetry requires that they are degenerate with respect to the azimuthal quantum number, m.

Known tabulated complex dielectric constants for various metals were taken from the established literature. Equation (1) is the denominator for the rate of plasmon interactions. An estimate of the enhancement is produced by taking the inverse of the mismatch of this equation at each wavelength. This is an estimate because if Equation (1) is satisfied exactly for both real and imaginary parts, an infinite enhancement is predicted. In practice, the imaginary part of Equation (1) is never exactly satisfied, thus limiting the maximum enhancement. Use of such theoretically-derived estimates is relatively well respected by the scientific community.

FIG. 8A shows predicted enhancement factors for a variety of different metals in which the angle and momentum of the plasmons is confined to the l=1 mode, where 1 is the angular momentum quantum number.

FIG. 8b shows predicted Raman enhancement factors for various metals in which voids confine plasmons to the l=2 mode.

Both FIGS. 8A and 8B indicate that by carefully selecting the size of the voids to match the plasmon modes that form in the voids, enhanced coupling can be obtained beyond that already found from our experiments. Enhancement factors ranging from about 10⁹ to about 10¹⁵ are predicted from the theoretical studies.

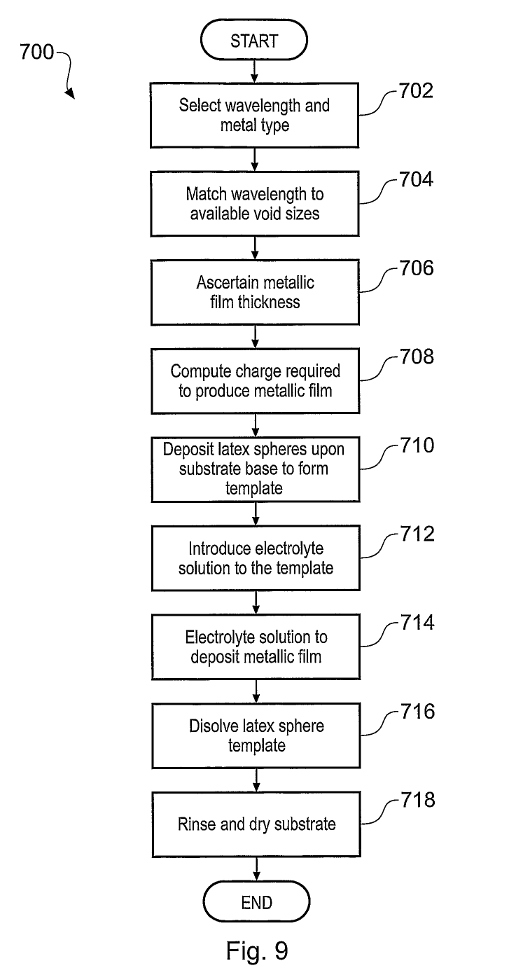

FIG. 9 is a flow diagram 700 illustrating a method of making a substrate having an enhanced efficiency of coupling optical energy to surface plasmons at a predetermined wavelength of optical radiation. The method relies upon using experimental and theoretical studies in order to optimise the performance of the substrate for any particular application by ensuring that voids provided in a metallic film give rise to strong plasmon generation for a particular desired wavelength of incident optical radiation.

Step 702 entails selecting a wavelength and a metal type for a particular application. Where the substrate is to be used for Raman spectroscopy this will depend on the sample material that is to be used. For example, the sample material will often have known peaks in its Raman spectra that are generally stronger than others. In this case, the wavelength can thus be selected in order to excite the various Raman spectral features of most interest. Further, the metal type may be selected in order to provide for minimal reactivity with the sample material so as to ensure that the spectral properties derive solely from the sample material and not from a combination of the sample material and the metal used to form the substrate.

Step 704 requires the matching of the wavelength selected for the sample material to the available void sizes that can be fabricated. In the technique used to manufacture the substrates according to this invention, a predetermined range of materials for forming the voids may be available. For example, the latex spheres used to manufacture the voids may only be available with a predetermined number and range of sizes. In order to form a matrix, one size that best matches the properties of the voids to the size of a void that can be made needs to be selected. For example, 700 nanometer diameter latex spheres are readily available and these can be used to form the voids.

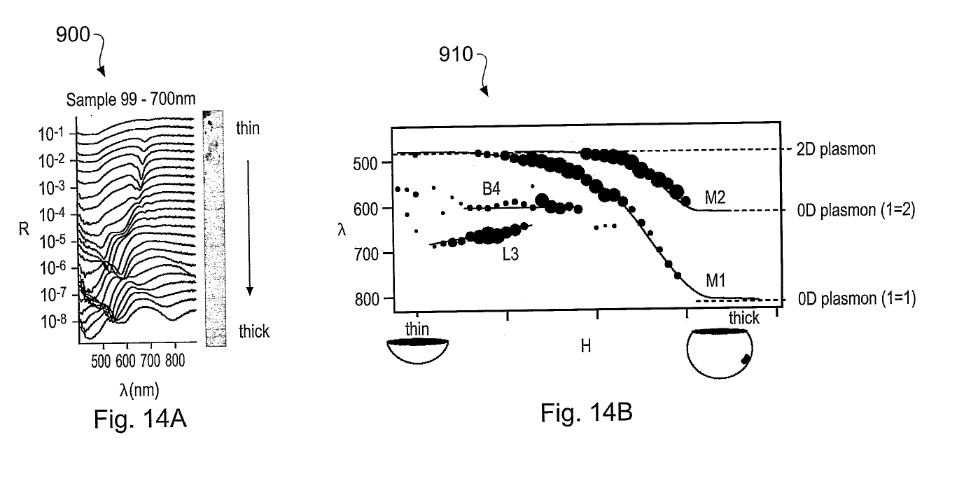

Step 706 involves ascertaining the thickness of the film needed to produce the desired optical response. Ascertaining the optimised thickness involves using the data shown in FIG. 14B in a normalised form to determine at what wavelength the localised plasmon resonance occurs for a particular void diameter. Since it is desirable to tune the exciting wavelength (and/or the SERS emission wavelength) to the localised plasmons, the film thickness may be selected using this technique.

Step 708 involves calculating the charge that needs to be used to provide the metallic film having the optical characteristics desired for use in the particular application for which the substrate is designed. The applicants have calibrated the charge/unit area required to grow films of particular thickness with particular void size. However, this calculation can also be derived from first principles by associating the deposition of each metal with a certain number of electrons, and then calculating from the geometry of the voids how many metal atoms need to be deposited to occupy a certain thickness.

Step 710 involves depositing latex spheres upon a substrate base to form a template. The technique of depositing the latex spheres and subsequently forming the metallic film on the substrate is described by the applicant in References 7, 10 and 11. The content of References 7, 10 and 11 are hereby incorporated herein by reference in their entirety.

Step 712 involves introducing an electrolyte solution to surround the latex spheres that form the template. The electrolyte solution comprises ions of the metal type previously chosen to form a metallic film. The electrolyte solution permeates the template.

At step 714 the electrolyte solution is electrolysed. A predetermined charge corresponding to that previously calculated is passed through the solution so that the metallic ions come out of solution and form the metallic film. The amount of charge determines the thickness of the metallic film that is deposited.

Step 716 the latex sphere template is dissolved using an organic solvent. Dissolving of the latex sphere template leaves a metallic substrate including voids formed where the latex spheres previously existed.

At step 718 the substrate is rinsed and dried in order to remove any traces of organic solvent and to provide a clean optically active surface for the metallic film.

Optionally, following the manufacture of various substrates, they can be coated with various sample materials. This allows ready made substrates to be provided that can be used to analyse specific sample materials. Various organic materials may be provided with substrates that selectively bind to specific target molecules. For example, various oligonucleotides (fragments of DNA or RNA) which target specific DNA or RNA sequences for selective binding may be provided along with the substrates.

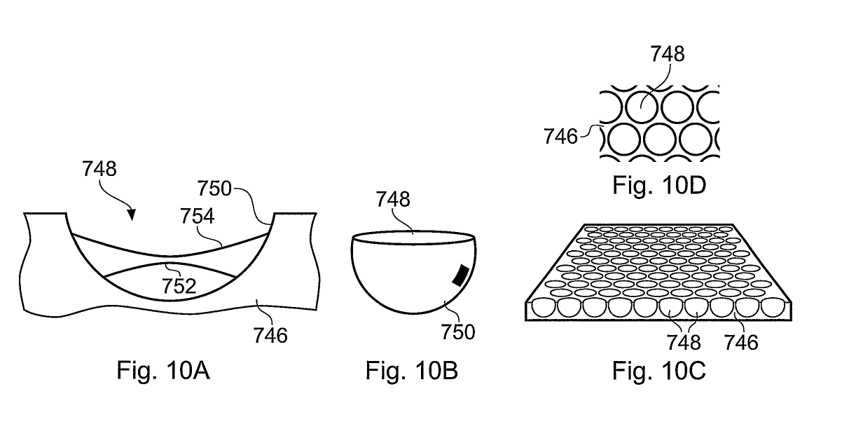

FIG. 10A shows a schematic illustration of a plasmon energy states 752, 754 formed in a void 748. The void 748 is defined by a void surface 750 that is formed in a metallic film 746. The voids 748 are shaped like part-spherical dishes of metal, and may be formed by electrochemically growing metal around a latex spherical former. The plasmons, which are electromagnetic modes, sit predominantly localised inside the spherical voids. Once the plasmons are excited, they decay either by radiating light or by transferring their energy to individual electrons in the surface 750 of the metal.

Void surfaces 750 can be designed so as to obtain plasmon resonances at a particular angle of incidence, based on the physical parameters of a metallic film. Light of a particular wavelength couples to localised plasmons in the voids only at particular angles of incidence, which can be predicted. The coupling depends upon the thickness of the film, the diameter of the spherical void, the type of metal and the optical polarisation.

FIG. 10B shows a schematic illustration of a void 748 having a truncated spherical shape.

FIG. 10C shows a perspective view of a metallic film 746 including a plurality of voids 748. The metallic film 746 can be incorporated in a substrate used in various embodiments of the invention.

FIG. 10D shows a plan view of the metallic film 746 shown in FIG. 10C. The plan view was obtained by imaging the metallic film 746 using a scanning electron microscope. The diameter of the latex spheres that were used as a template to form the metallic film 746 was 700 nanometers.

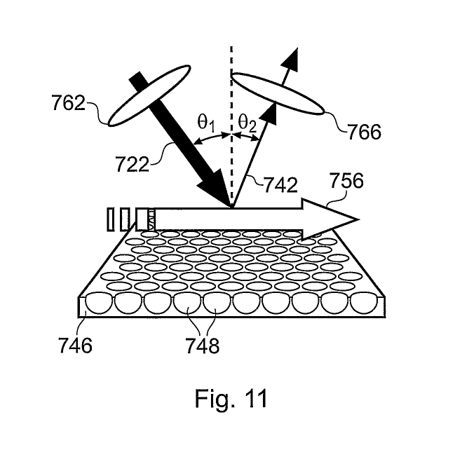

FIG. 11 schematically shows the Raman spectrometer 200 shown in FIG. 2 in one mode of operation. Optical radiation 722 is focussed through a first lens 762 onto a metallic film 746. The metallic film 746 comprises a plurality of voids 748. A fluid containing sample material flows over the metallic film 746 in the direction of the arrow 756. Raman scattered radiation 742 is generated by the sample material. The Raman scattered radiation 742 is collected by a second lens 766 and subsequently analysed to derive the Raman spectrum. The emission of the surface enhanced Raman scattered light is at a different angle (θ₂) from the incident optical radiation (θ₁). The metallic film 746 can be engineered to provide a spectrometer in which it is not necessary to use high numerical aperture lenses. High numerical aperture lenses have a short working distance from the sample so as to capture light emerging from the sample from as many angles of emission as possible. Embodiments of the invention enable larger areas of the substrate to be examined simultaneously. This also increases the Raman signal that is observed because more photons are gathered. Furthermore, the Raman signal can be collected by optics that do not necessarily need to be placed close to the substrate surface.

We have also shown that it is possible directly to observe real time changes in the chemistry of a sample material monolayer at the surface of the substrate. The substrate is placed in a solution containing sample material. The optical radiation passes through the solution and excites the sample material proximal to the substrate. By applying a potential to the solution by placing an electric potential on the substrate surface, molecules of sample material can be selectively electrochemically bound to the surface. Previously this was impractical because it was difficult to separate Raman scattered photons generated close to the surface from Raman scattered photons generated by molecules in solution remote from the surface. However, now since the surface molecules provide an enhanced Raman signal, Raman signal arising from sample material near the surface dominates, swamping any Raman signal arising from the body of the solution away from the surface.

The invention therefore enables real time tracking of the progress of surface chemical reactions with the possibility of initiating the surface chemical reactions using laser pulses to excite sample material molecules via plasmons generated in the voids. The study of small numbers of molecules contained in a single void is also made possible by the enhanced Raman signal. In addition, our theoretical studies predicted that enhanced Raman signals are also derivable using a platinum-based substrate or a palladium-based substrate. This allows for the direct study of catalysis.

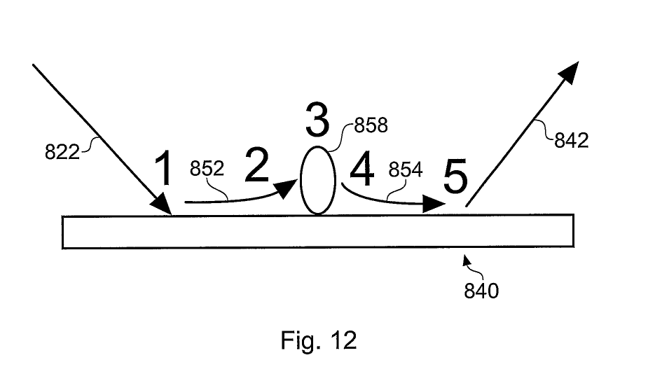

FIG. 12 schematically illustrates the process of surface enhanced Raman spectroscopy. A photon of optical radiation 822 is incident on the metallic surface of the substrate 840. The photon is incident on the metallic surface and gives rise to an electromagnetic disturbance in the form of a surface plasmon 852. The surface plasmon 852 couples energy from the surface of the substrate 840 into sample material 858. The plasmon energy couples with the energy of a phonon and converts into a further surface plasmon 854. The plasmon 854 subsequently transfers energy to a Raman scattered photon 842.

A flat metal film does not efficiently convert incident light to plasmons or plasmons into emitted photons. The voids of the present invention, however, provide a controlled way of doing this by careful choice of the void size and shape.

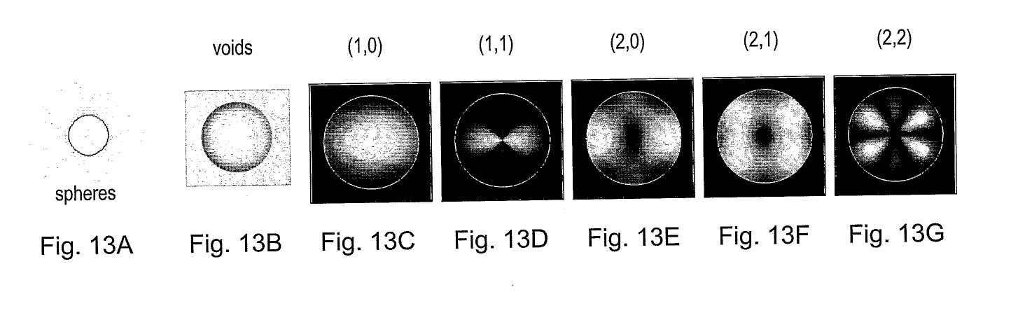

FIG. 13A schematically shows the plasmon field strength on a metallic sphere. The plasmon intensity on the surface of the sphere, and in its vicinity, is not high and decays only slowly. This means that plasmons generated on the surface of metallic spheres are not best suited to coupling energy from incident photons to any sample material that is placed near to the spheres in order to obtain an enhanced Raman signal. This is one reason why various roughened surfaces used in existing SERS devices are less effective.

FIGS. 13B to 13G schematically show plasmon field strengths for a perfect spherical void. FIGS. 13C to 13G show how the plasmon field strengths appear as different modes depending on the angular momentum (l,m) of the plasmons that are excited. In each case it can be seen that at least one high field strength “hot spot” develops, as indicated by the light coloration regions shown within the voids. The high field strength enables energy to be coupled efficiently from incident optical radiation into sample materials that are placed in or near to the voids.

FIG. 14A shows a reflection spectrum for different thickness voids as the thickness increases from near zero (thin) to about 700 nanometres (thick). Optical radiation is incident normal to the substrate surface.

FIG. 14B shows plasmon modes for different thickness truncated spherical voids in a gold metallic film. The metallic film is the same as that used to provide the results shown in FIG. 14A. The plasmon modes have been extracted from the reflectivity data and their energies are compared with the energy of the plasmon on a flat gold film, i.e. a two-dimensional (2D) plasmon. The energies of the plasmons are also compared to those of a perfect spherical void, i.e. a zero-dimensional (0D) plasmon, for different angular momentum values l=1 and l=2. The localised plasmons (known as Mie modes, M1 and M2) start out with an energy equal to the 2D plasmons for a very shallow void. As the void gets thicker the energy drops, tending to the energy of a complete spherical void as the thickness approaches 700 nanometers. This is clearly seen in the data, which also shows the theoretical limits (2D and 0D), and the experimental data moving smoothly between them. This information is useful as it enables tailored metallic films to be produced that efficiently couple optical radiation of a particular wavelength into plasmons.

Two additional modes are also seen in the data. These are known as a localised mode (L3) and a Bragg mode (B4). The localised mode (L3) arises from 2D plasmons which move along the flat gold surface in between the voids. These can become localised in the gaps above the voids rather than on the gold in between the voids. It is expected that this mode will also give rise to an enhanced Raman signal.

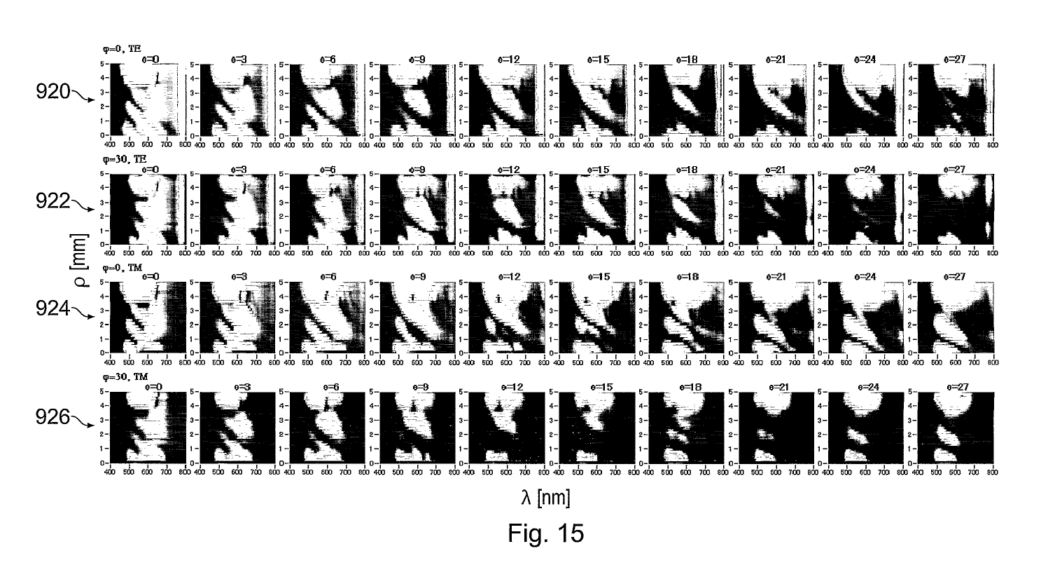

FIG. 15 shows data indicating how the reflectivity of a gold metallic film of varying thickness varies according to the wavelength of incident optical radiation and for different angles of incident polarisation and metallic film orientation.

The substrate comprises metallic film made of gold. The metallic film was some 5 mm long. Voids formed in the metallic film varied in depth from zero (i.e. flat) at the zero mm position to 700 nanometers at the 5 mm position. The angle φ represents the angle of rotation of the sample about the surface normal. The surface has sixfold symmetry due to the hexagonal packing of the truncated spherical voids, and hence rotation was made between 0° and 30°. The angle θ corresponds to the angle of incidence of the optical radiation with respect to the surface of the substrate. Normal incidence is at 0° and measurements were made up to 27° incrementally in steps of 3°. Measurements were made for both the transverse electric and the transverse magnetic field. Further details of the optical set-up for obtaining these results can be found in Reference 8.

The data indicates that whereas a perfectly spherical void has no angular dependence, truncated spherical voids give rise to localised plasmons that emit at different wavelengths in different directions. Each mode changes wavelength with angle in a way that can be predicted from a comparison with experimental results or from modified experimental results derived from theory. By truncating spherical voids a coupling together of dipole, quadruple, hexapole, etc. plasmons occurs which shifts the coupled plasmon modes to a higher energy and introduces angular dependence. The presence of a strong optical field for some of these modes on a metal boundary (for example (l, m)=(1, 0), (2, 0)) is what allows light impinging on the structure to couple strongly to the localised plasmons. This process can be modelled. (For example, see FIGS. 8A and 8B.) Moreover, using the applicant's data, it has been possible to produce substrates with voids that confine plasmons in both platinum and nickel. Both of these materials are interesting because of their catalytic properties.

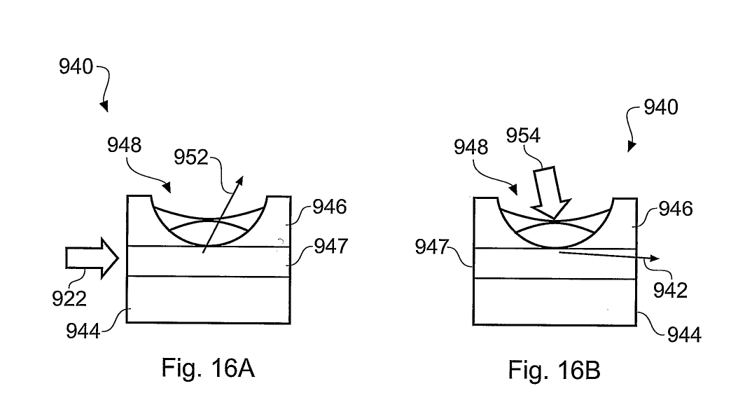

FIG. 16A shows a schematic illustration of a plasmon formed in a void by coupling of optical radiation from a waveguide formed in a substrate. The substrate 940 comprises a support layer 944 made using low refractive index glass. A high refractive index glass waveguide layer 947 is formed over the support layer 944. Metallic film 946 incorporating a plurality of voids 948 is formed on the waveguide layer 947. Optical radiation 922 is guided in the waveguide layer 947.

Where the voids 948 are in close proximity to the waveguide layer 947 optical radiation 922 can couple to the surface of the voids 948. This coupling generates plasmons in a void 948. The plasmons 952 are able to couple to sample material in the voids 948 and generate Raman scattered radiation 942. Some of the Raman scattered radiation 942 couples back into the waveguide layer 947 and can be detected remote from the voids 948.

By combining the voids with an optical waveguide, either the input optical radiation or the output surface enhanced Raman signal, or both, can be injected/collected through the waveguide. In a first version, optical radiation is fed in through the optical waveguide and couples to the localised plasmons via evanescent coupling. The applicants have made such a device using a gold metallic film formed on an indium tin oxide (ITO) layer forming a waveguide over a glass support layer.

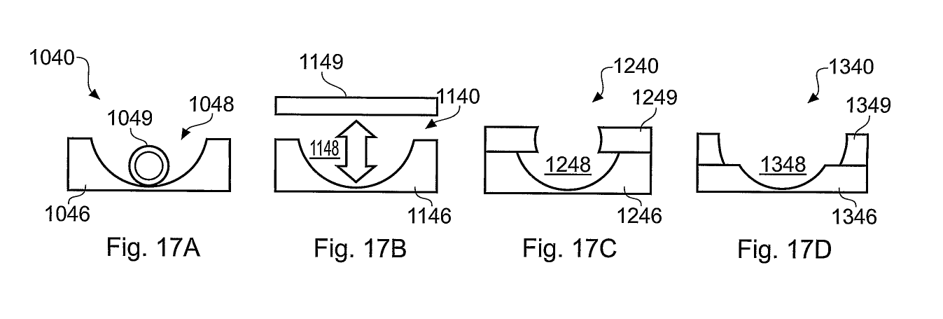

FIGS. 17A to 17D show various schemes for improving the coupling of optical radiation into sample materials by modifying the geometry of the voids. In FIG. 17A a metal sphere 1049 is placed in the void 1048. The metal sphere can be a gold, silver or copper sphere which is either solid or which has a dielectric core. Theoretical predictions indicate that use of such a sphere 1049 will give rise to a further enhanced Raman signal.

FIG. 17B shows a mirror device 1149 placed above the void 1148 in order to form a microcavity. The microcavity enhances the Raman signal by selecting certain wavelength bands for amplification. By adjusting the length of the cavity, a particular set of wavelength bands can be amplified. The mirror device 1149 can be a dielectric Bragg reflector, or a thin metallic layer. Additionally, this geometry allows MEMS devices to be constructed in conjunction with the substrate.

FIGS. 17C and 17D illustrate how electrochemically grown metal over-layers can be provided to produce a modified void. In FIG. 17C gold layer 1246 is provided with an overhanging silver layer 1249. In FIG. 17D gold layer 1346 is provided with an over-etched silver layer 1349.

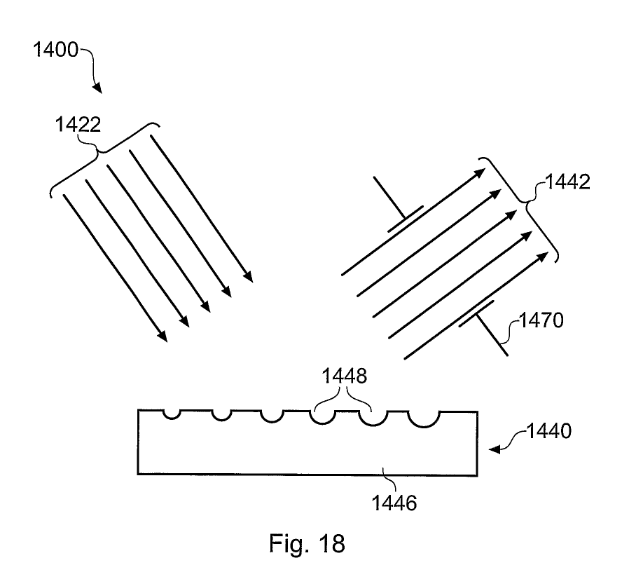

FIG. 18 shows an optical device 1400 for filtering optical radiation 1422. The optical device 1400 comprises a substrate 1440 having a metallic film 1446 that includes a plurality of voids 1448. The voids 1448 are designed to emit radiation of a particular wavelength at a particular angle. The optical device 1400 incorporates an optical aperture 1470 for blocking radiation which does not emerge from the substrate 1440 at a particular predetermined angle. Only radiation 1442 having a predetermined wavelength is able to emerge from the optical device 1400. Thus, the optical device 1400 acts to filter the optical radiation 1422.

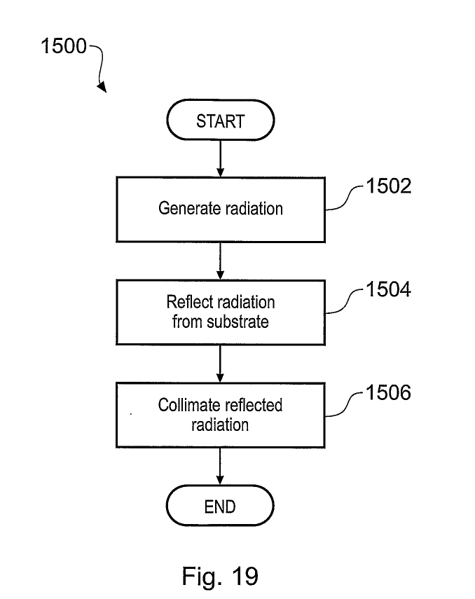

FIG. 19 is a flow diagram 1500 illustrating a method of using the optical device 1400 shown in FIG. 18.

Step 1502 requires the generation of radiation which is to be filtered. The optical radiation is provided to the optical device.

Step 1504 entails reflecting of the radiation to be filtered from a substrate. The substrate disperses the radiation according to its wavelength. Radiation of a particular predetermined wavelength leaves a surface of the substrate at a particular predetermined angle.

Step 1506 comprises collimating reflected radiation in order to remove the components of the incident radiation that do not emerge from the substrate at a particular predetermined angle. In one example, a pinhole or the like may be used to selectively block dispersed optical radiation. The angular dispersion and collimation of the radiation reflected from the substrate therefore enables the incident optical radiation to be filtered.

Whilst the invention has been described in relation to various embodiments, many variations will be envisaged by the skilled person. For example, one possibility is to take an existing fibre optic probe and create a semitransparent substrate on top of this so that light can couple from the fibre optic onto the substrate and so that SERS photons can be detected in a direction back down the fibre optic. Such a probe can be fabricated as an immersible probe without a microscope objective or other lens. Moreover, those skilled in the art will realise that various features of different embodiments may be combined as necessary to obtain still further embodiments of the invention.

### REFERENCES

1. U.S. Pat. No. 6,242,264
2. US 2003/0157732
3. U.S. Pat. No. 5,376,556
4. “Confined Plasmons in Metallic Nanocavities,” S. Coyle, M. C. Netti, J. J. Baumberg, M. A. Ghanem, P. R. Birkin, P. N. Bartlett and D. M. Whittaker, Physical Review Letters, Volume 87, Number 17, 176801 (2001)
5. “Confined Plasmons in Gold Photonic Nanocavities,” M. C. Netti, S. Coyle, J. J. Baumberg, M. A. Ghanem, P. R. Birkin, P. N. Bartlett and D. M. Whittaker, Advanced Materials, Volume 13, Number 18, 1368 (2001)
6. “Spherical micromirrors from templated self-assembly: Polarization rotation on the micron scale,” S. Coyle, G. V. Prakash, J. J. Baumberg, M. Abdelsalem and P. N. Bartlett, Applied Physics Letters, Volume 83, Number 4, 767 (2003)
7. “Highly Ordered Macroporous Gold and Platinum Films Formed by Electrochemical Deposition through Templates Assembled from Submicron Diameter Monodisperse Polystyrene Spheres,” P. N. Bartlett, J. J. Baumberg, P. R. Birkin, M. A. Ghanem and M. C. Netti, Chemical Materials, Volume 14, Number 5, 2199 (2002)
8. Baumberg et al, Applied Physics Letters, Volume 76, 991 (2000)
9. WO-A1-02/42836
10. “Optical properties of nanostructured metal films,” P. N. Bartlett, J. J. Baumberg, S. Coyle and M. Abdelsalem, Faraday Discussions, 125/19 (2003)
11. “Preparation of Arrays of Isolated Spherical Cavities by Self-Assembly of Polystyrene Spheres on Self-Assembled Pre-patterned Macroporous Films,” M. Abdelsalem, P. N. Bartlett, J. J. Baumberg and S. Coyle, Advanced Materials, Volume 16, Number 1, 90 (2004)

1. A spectrometer for obtaining a Raman spectrum from a sample material, the spectrometer comprising:
an optical source for generating optical radiation;
a substrate for receiving the optical radiation, the substrate comprising a metallic film incorporating a plurality of voids of a predetermined size for confining surface plasmons, wherein the surface plasmons are for coupling energy from the optical radiation to a sample material when located proximal the substrate and for converting scattered energy emitted from the sample material into Raman scattered radiation; and
a spectral analyser for analysing the Raman scattered radiation emerging from the substrate.

2. The spectrometer of claim 1, wherein the voids have the shape of a truncated sphere.

3. The spectrometer of claim 2, wherein the voids have a diameter from about 50 nm to about 10,000 nm.

4. The spectrometer of claim 1, wherein the substrate is generally planar in shape and the voids are uniformly spaced over at least part of a planar surface of the substrate.

5. The spectrometer of claim 1, wherein the substrate further comprises a waveguide structure for coupling the optical radiation to a sample material through the metallic film.

6. The spectrometer of claim 5, wherein the spectral analyser is further configured to collect Raman scattered radiation that emerges from the waveguide.

7. The spectrometer of claim 1, wherein the spectral analyser comprises input channel optics for collecting the Raman scattered radiation emerging from the substrate.

8. The spectrometer of claim 7, wherein the input channel optics has a numerical aperture less than 0.4.

9. The spectrometer of claim 7, wherein the input channel optics comprises a fibre optic input channel oriented towards the substrate.

10. The spectrometer of claim 1, wherein optical source comprises a laser diode array.

11. A method of obtaining a Raman spectrum from sample material, the method comprising:
providing a Raman spectrometer comprising: an optical source for generating optical radiation; a substrate for receiving the optical radiation, the substrate comprising a metallic film incorporating a plurality of voids of a predetermined size for confining surface plasmons, wherein the surface plasmons are for coupling energy from the optical radiation to a sample material when located proximal the substrate and for converting scattered energy emitted from the sample material into Raman scattered radiation; and a spectral analyser for analysing the Raman scattered radiation emerging from the substrate;
introducing sample material into the spectrometer proximal to the substrate;
activating the optical source; and
operating the spectral analyser to provide the Raman spectrum of the sample material.

12. The method of claim 11, wherein the step of introducing sample material comprises flowing a fluid containing the sample material across the substrate in a region illuminated by the optical radiation.

13. The method of claim 11, further comprising varying the electric potential of the metallic film of the substrate.

14. A method of making a substrate having an enhanced efficiency of coupling optical energy to surface plasmons at a predetermined wavelength of optical radiation incident upon the substrate, the method comprising:
determining the size and shape of voids which when formed in a metallic film efficiently couple optical energy at the predetermined wavelength to surface plasmons that form in the voids; and
forming a substrate comprising a metallic film that includes a plurality of voids of the determined size and shape.

15. The method of claim 14, comprising forming voids in the metallic film that are uniformly spaced over a surface of the substrate.

16. The method of claim 14, further comprising forming a waveguide structure in the substrate for coupling optical radiation from the substrate through the metallic film.

17. The method of claim 14, wherein determining the size and shape of the voids comprises determining the size and shape of a truncated spherical void.

18. The method of claim 17, wherein the diameter of the truncated spherical void is chosen to be of the same order of magnitude as the predetermined wavelength of optical radiation.

19. The method of claim 18, wherein voids have a diameter from about 50 nm to about 10,000 nm.

20. The method of claim 17, wherein the thickness of the voids is chosen so as to couple optical energy at the predetermined wavelength to zero-dimensional plasmons that form in the voids.

21. The method of claim 14, wherein the step of forming a substrate comprises:
depositing a template of ordered spherical particles on a substrate surface; and
passing a predetermined amount of charge though a metallic ion containing solution that surrounds the template so as to deposit the metallic film on the substrate surface.

22. A substrate made according to the method of claim 14.

23. The substrate of claim 22, wherein the metallic film comprises one or more of the following materials: gold, platinum, silver, copper, palladium, cobalt and nickel.

24. The substrate of claim 22, further comprising a sample material for analysis provided in the voids of the metallic film.

25. The substrate of claim 24, wherein the sample material is an organic material that selectively binds to a specific target molecule.

26. An optical device incorporating the substrate according to claim 22.

27. (canceled)
